(19) United States
(12) Patent Application Publication
(10) Pub. No.: US 2017/0064353 A1
(43) Pub. Date: Mar. 2, 2017

(54) PLANNED VIDEO PRODUCTION SYSTEM WITH FEEDBACK

(71) Applicants: Thomas Kwangsung KIM, Mission Viejo, CA (US); Veronica Kim REYES, Irvine, CA (US)

(72) Inventors: Thomas Kwangsung KIM, Mission Viejo, CA (US); Veronica Kim REYES, Irvine, CA (US)

(21) Appl. No.: 14/834,829

(22) Filed: Aug. 25, 2015

(51) Int. Cl. H04N 21/25; H04N 21/2368; H04N 21/442; H04N 21/2343; H04N 21/262

(52) U.S. Cl. CPC H04N 21/252; H04N 21/23439; H04N 21/26258; H04N 21/44222; H04N 21/2368

(57) ABSTRACT

A planned video production system with feedback comprises a first planner module, a second planner module, a producer module, a player module, a feedback module, and a reward module. The first planner module comprises a playlist with storyboard configured for storing production idea, and is configured for selecting production data for the production idea directly on the playlist, and completing a functional storyboard. The second planner module is configured for selecting and making templates in ready-made contents, replacing or correcting a portion of the production data on the playlist. The producer module is configured for playing information of all the clips and events stored with a storyboard on the playlist in the first and second planning modules, and recording or transmitting procedure of playing of storyboard using switcher functions. The player module displays corresponding playlist and finds a point to correct. The feedback module and reward module interact with users.

### BACKGROUND OF THE INVENTION

The present invention relates to a planned video production system with feedback. More particularly, this invention relates to a planned video production system with feedback.

In prior arts, video productions are time-consuming and hard to automate their processes.

Still, with the advent of the era of information and the Internet, video is one of the most frequently produced and consumed in everyday lives of general people.

Therefore, if even some of procedure for producing video can be improved, its effects on the information society will be astounding.

Accordingly, a need for a planned video production system with feedback has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a planned video production system with feedback.

The planned video production system with feedback comprises a first planner module, a second planner module, a producer module, a player module, a feedback module, and a reward module.

The first planner module comprises a playlist with storyboard configured for storing production idea, and is configured for selecting production data comprising live source, movie clip, audio clip, image, text, and graphics for the production idea directly on the playlist, and completing a functional storyboard.

The second planner module is configured for selecting and making templates in ready-made contents, which is similar to contents-to-make, replacing or correcting a portion of the production data comprising video clip, audio clip, text clip, graphics clip, or event on the playlist while following or jumping over the production data in a predetermined order on the storyboard, and making the contents-to-make.

The producer module is configured for playing information of all the clips and events stored with a storyboard on the playlist in the first and second planning modules, and recording or transmitting procedure of playing of storyboard in real-time and online or offline using manual or automatic switcher functions, each of which being customized for each type of clips.

The player module is configured so that, while playing contents made in the producer module to an audience through a video on demand (VOD) or at a predetermined time using a time scheduler, when it is necessary to change a portion of the contents, if selecting the portion of the contents to change, the player module displays a corresponding playlist and finds a point to correct on the playlist.

The feedback module is configured for making a plurality of questionnaires of 2-dimensional, 3-dimensional, text, and graphics including image and animation into questionnaire-templates, storing the questionnaire-templates in a database, analyzing feedback data from the audience according to the user's necessity, and displaying an analyzed results in 2-dimensional, 3-dimensional, text, and graphics image, or animation.

The reward module is configured for summarizing the feedback data of each audience, presenting an individual score reflecting the summarized feedback data, providing a reward to the audience according to a policy of a system user.

The first planner module may be further configured for allowing the user to determine production data on the timeline at the same time while making the storyboard, so as to enable the player module to perform a file recording or a live broadcasting directly without additional works using a completed playlist.

The first planner module may be configured to deal with three types of clips of video, audio, and text and graphic (CG), and when it is needed to broadcast several events and clips simultaneously on a screen, a number of lines in the playlist is increased such as Video 1, Video 2, Video 3, . . . , Video n, Audio 1, Audio 2, Audio 3, . . . , Audio n, and CG1, CG2, CG3, . . . , Cgn.

If a contents made by the second planner module is loaded so as to dispose events and clips on the playlist, entire or partial portions of the contents may be converted to templates and each of the events or clips may be able to be replaced with another desired event or clip individually, such that empty or overlapped play time is rearranged automatically.

When the producer module combines a plurality of live video and audio source from outside with video clip, audio clip, or CG clip that were made already and broadcasts in real-time through switching and mixing, broadcasting times for input source, video clip, audio clip, and CG clip may be predetermined, such that the live broadcasting in real-time is performed by using an automatic button.

A broadcasting order of the input source, the video clip, the audio clip, and the CG clip and broadcasting start point and end point for each of them may be assigned and the assigned information is represented on corresponding event or clip and concurrently the event and clip including live source, video clip, and CG are disposed automatically on assigned positions of the playlist.

When the video clip, the audio clip, and the CG clip provided by the producer module are broadcast, properties of control buttons of the producer module may change according to the kind of the video, audio, and CG automatically so as to optimize the control buttons.

The reward module may be further configured for allowing each of the audiences to see score that the audience won by providing an individual database, reading out score data accumulated in the individual database, and sending a content of the score data that the audience wants to a mobile device or terminal of the audience, such that the audience gets interested in results of feedback and is encouraged for a further participation.

The advantages of the present invention are: (1) the planned video production system according to the invention revolutionizes video production; and (2) the planned video production enables real-time operations.

Although the present invention is briefly summarized, the fuller understanding of the invention can be obtained by the following drawings, detailed description and appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and other features, aspects and advantages of the present invention will become better understood with reference to the accompanying drawings, wherein:

FIG. 1 is a block diagram showing a planned video production system with feedback according to an embodiment of the invention;

FIG. 2 is a flowchart showing operations of the planned video production system of FIG. 1;

FIGS. 3-13 show exemplary steps performed by a first planner module according to an embodiment of the invention;

FIGS. 14-20 show exemplary steps performed by a second planner module according to an embodiment of the invention;

FIGS. 21-44 show exemplary steps performed by a producer module according to an embodiment of the invention;

FIGS. 45-46 show exemplary steps performed by a first player module according to an embodiment of the invention;

FIGS. 47-53 show exemplary steps performed by a feedback module according to an embodiment of the invention; and

FIG. 54 show an output screen shot by a reward module according to an embodiment of the invention.

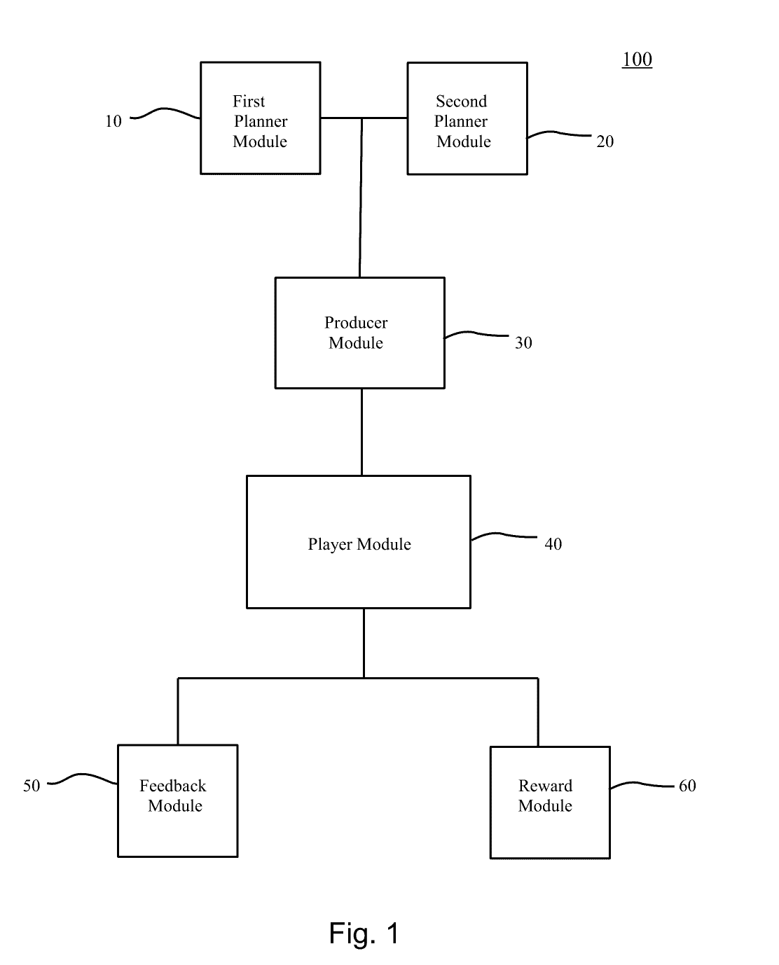

### DETAILED DESCRIPTION EMBODIMENTS OF THE INVENTION

An object of the invention is to provide a planned video production system with feedback.

According to an aspect of the invention, the planned video production system 100 with feedback comprises a first planner module 10, a second planner module 20, a producer module 30, a player module 40, a feedback module 50, and a reward module 60.

The first planner module 10 comprises a playlist with storyboard configured for storing production idea, and is configured for selecting production data comprising live source, movie clip, audio clip, image, text, and graphics for the production idea directly on the playlist, and completing a functional storyboard.

The second planner module 20 is configured for selecting and making templates in ready-made contents, which is similar to contents-to-make, replacing or correcting a portion of the production data comprising video clip, audio clip, text clip, graphics clip, or event on the playlist while following or jumping over the production data in a predetermined order on the storyboard, and making the contents-to-make.

The producer module 30 is configured for playing information of all the clips and events stored with a storyboard on the playlist in the first and second planning modules 10, 20, and recording or transmitting procedure of playing of storyboard in real-time and online or offline using manual or automatic switcher functions, each of which being customized for each type of clips.

The player module 40 is configured so that, while playing contents made in the producer module 30 to an audience through a video on demand (VOD) or at a predetermined time using a time scheduler, when it is necessary to change a portion of the contents, if selecting the portion of the contents to change, the player module 40 displays a corresponding playlist and finds a point to correct on the playlist.

The feedback module 50 is configured for making a plurality of questionnaires of 2-dimensional, 3-dimensional, text, and graphics including image and animation into questionnaire-templates, storing the questionnaire-templates in a database, analyzing feedback data from the audience according to the user's necessity, and displaying an analyzed results in 2-dimensional, 3-dimensional, text, and graphics image, or animation.

The reward module 60 is configured for summarizing the feedback data of each audience, presenting an individual score reflecting the summarized feedback data, providing a reward to the audience according to a policy of a system user.

The first planner module 10 may be further configured for allowing the user to determine production data on the timeline at the same time while making the storyboard, so as to enable the player module 40 to perform a file recording or a live broadcasting directly without additional works using a completed playlist.

The first planner module 10 may be configured to deal with three types of clips of video, audio, and text and graphic (CG), and when it is needed to broadcast several events and clips simultaneously on a screen, a number of lines in the playlist is increased such as Video 1, Video 2, Video 3, . . . , Video n, Audio 1, Audio 2, Audio 3, . . . , Audio n, and CG1, CG2, CG3, . . . , CGn.

If a contents made by the second planner module 20 is loaded so as to dispose events and clips on the playlist, entire or partial portions of the contents may be converted to templates and each of the events or clips may be able to be replaced with another desired event or clip individually, such that empty or overlapped play time is rearranged automatically.

When the producer module 30 combines a plurality of live video and audio source from outside with video clip, audio clip, or CG clip that were made already and broadcasts in real-time through switching and mixing, broadcasting times for input source, video clip, audio clip, and CG clip may be predetermined, such that the live broadcasting in real-time is performed by using an automatic button.

A broadcasting order of the input source, the video clip, the audio clip, and the CG clip and broadcasting start point and end point for each of them may be assigned and the assigned information is represented on corresponding event or clip and concurrently the event and clip including live source, video clip, and CG are disposed automatically on assigned positions of the playlist.

When the video clip, the audio clip, and the CG clip provided by the producer module 30 are broadcast, properties of control buttons of the producer module 30 may change according to the kind of the video, audio, and CG automatically so as to optimize the control buttons.

The reward module 60 may be further configured for allowing each of the audiences to see score that the audience won by providing an individual database, reading out score data accumulated in the individual database, and sending a content of the score data that the audience wants to a mobile device or terminal of the audience, such that the audience gets interested in results of feedback and is encouraged for a further participation.

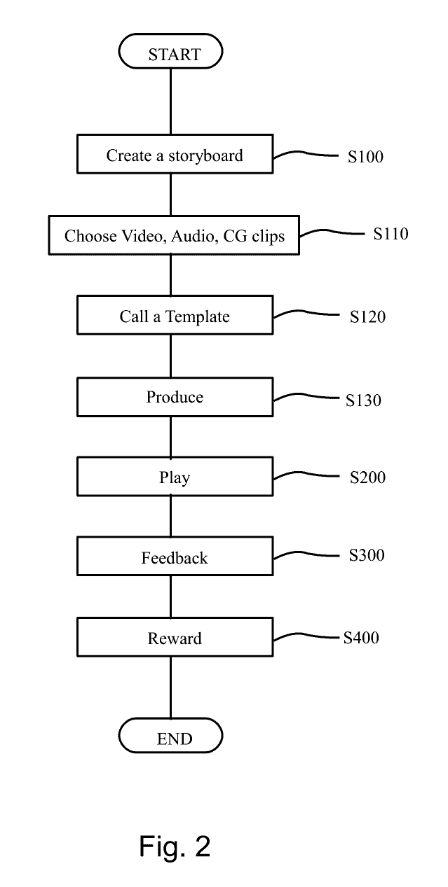

FIG. 2 shows a flowchart for the system. Below, the operation of the system is described a detail.

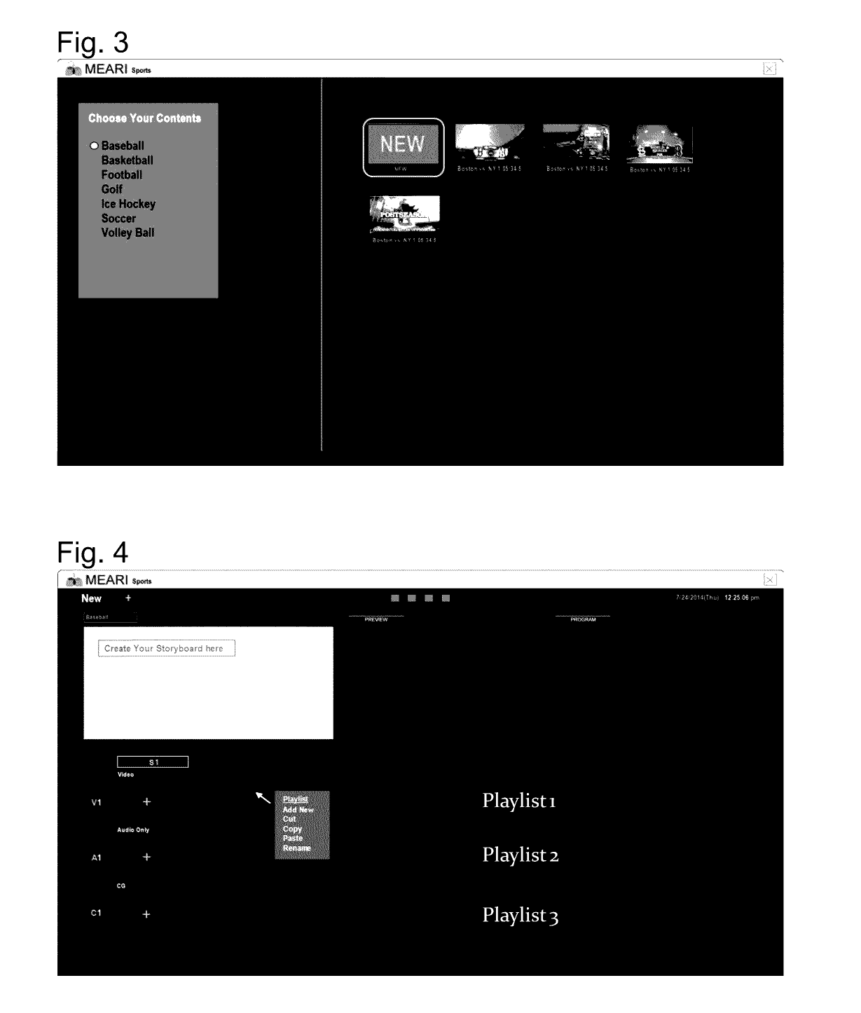

In FIG. 3, the planned video production (PVP) system according to the invention is a beginning user interface (UI) for applying a sports contents industry, which can be realized in an information processing environments such as a computer, an Internet, and a mobile communication. FIG. 3 can be a screen shot in such an information processing devices such as a desktop computer or other computing devices. On the left side of the screen, an interested sport can be chosen, and on the right side, contents related to the chosen sport may be selected to watch. In order to make a new contents, the user may choose “New”.

In FIG. 4, if New is selected, a Main UI of the PVP system appears. The name of Tab on the left top of the screen in “New”, but if the contents are stored, it will change to a new name. The feature of the Main UI is that it has a Storyboard Number. If pressing a number the user can write a Storyboard on a Source window. In this UI, the first Storyboard Number is given. (S1, the highlighted). And, in the Playlist, Video and Audio only are added to the CG, and the Playlist may be added or removed if needed. In order to add or delete, right mouse button may be used on the Playlist. If Add is seleceted a new Playlist appears below a same kind of Playlist automatically according to the kind of selected Playlist (one of Video, Audio, or CG).

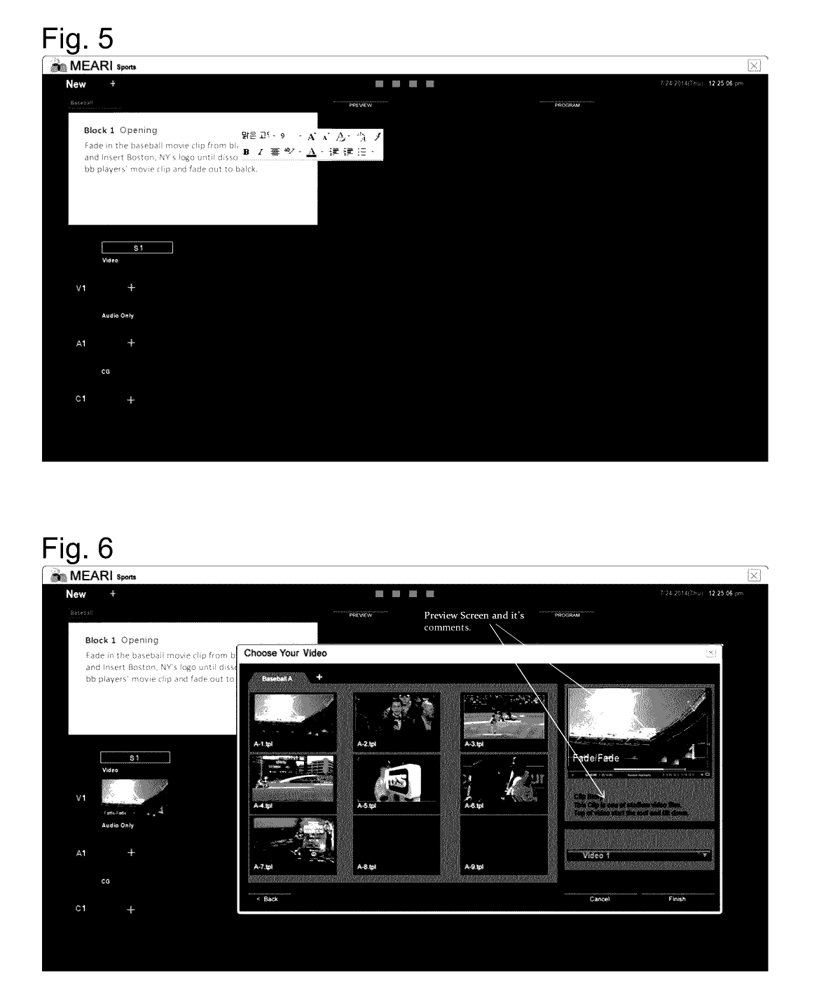

In FIG. 5, a first Storyboard is made. The contents to make may be written directly to the Storyboard while thinking them, or a story written in a word processor program may be read in. Since a small Word Menu appears while writing, the font kind, size, color, etc. may be assigned. In the Storyboard, how the contents is plotted or necessary information can be recorded. If the first Storyboard is done, Video, Audio, and CG can be selected according to the Story. First in the Playlist, by clicking +Screen in the Video Playlist, a Video source may be read in.

In FIG. 6, if pressing +Screen in the Video Playlist, a Choose Video window pops up so as to select a Source Video. In order to choose a Video Clip suitable for the 0, double click the Clip window. The Clip loaded in the Preview window in the right of the Choose window will starts to play. An explanation of the Clip will be shown under it. In the Preview window is a Clip Editor, and the selected Video Clip can be edited at the same time.

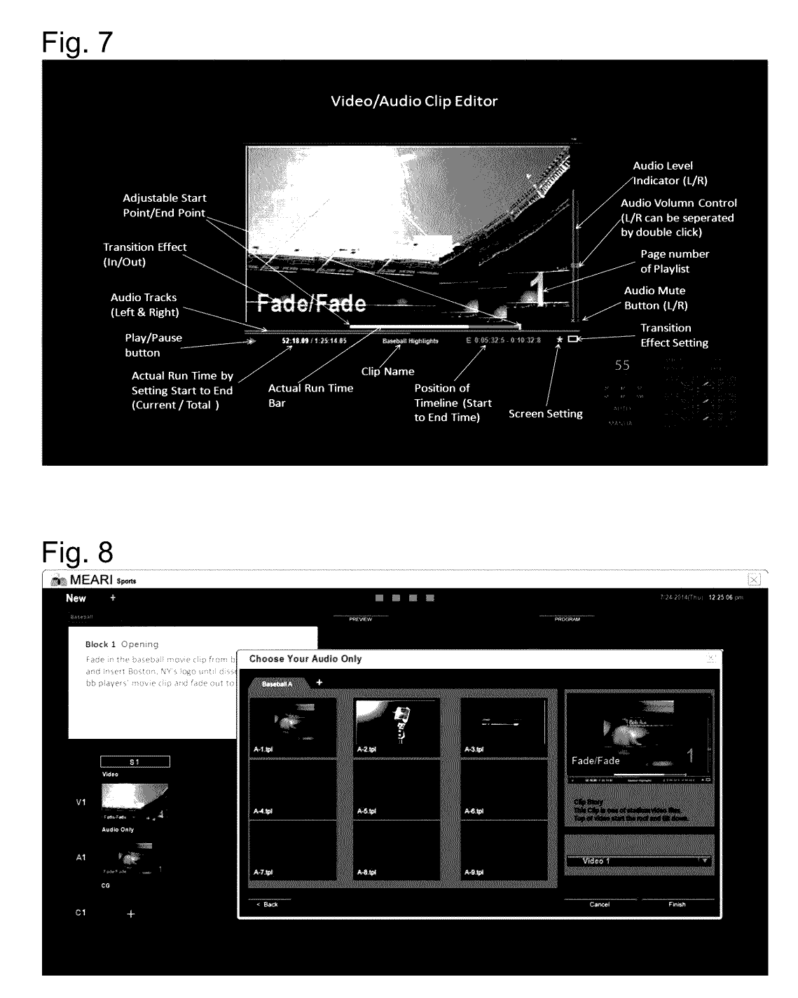

In FIG. 7, the Clip Editor only is enlarged. In this window, all functions related to Clip can be set. The Clip Editor may be used exactly same in the Preview window of the Main UI. Actual Run Time bar: a function to select a necessary scenes in the entire Video Clip. The necessary scenes can be determined by Start Point and End Point. Once the scenes are determined then the time is displayed in the bottom. Play/Pause Button: The determined scene starts to play if the Start Button is pressed. The yellow bar proceeds to the End Point. Pressing of the button one more time brings about a state of Pause, and one more press will release the state. Audio Track and Volume: Audio Track has two parallel bars, white and red, horizontally. If pressing the Play Button, the sound is played from the Start Point. Audio Volume can be controlled through two lines in the right end portion. Volume Controller is in the middle. It can be Mute. Transition Effect: In or Out effect can be selected from Effect Pop Up window, and the chosen one is displayed as characters. It includes Cut, Fade, Effect Pattern, and Transition Time. Position Timeline: Showing the position of Clip in the Timeline. Determining the Clip's starting and ending on the Timeline, and if changing the time, the position on the Timeline is changed. Besides, it may have features of recording Clip Name, showing Page number as the order of the Playlist automatically, and Screen Setting for adjusting screen size or resolution.

In FIG. 8, since the first Storyboard (S1) records the Opening, appropriate Video, Audio, CG clips, etc. are chosen. A stadium is chosen for Video, and one of Audio files is selected. The Audio that was along with Video was determined not to use, it was Muted, and then select “+” in the second Playlist and select ‘Sleep away’ in Choose Your Audio Only window (first Audio Clip). Since Audio should be used by Sneak In along with Video, Audio Effect of Fade In (=Sneak IN) and Fade Out (Sneak Out) is chosen.

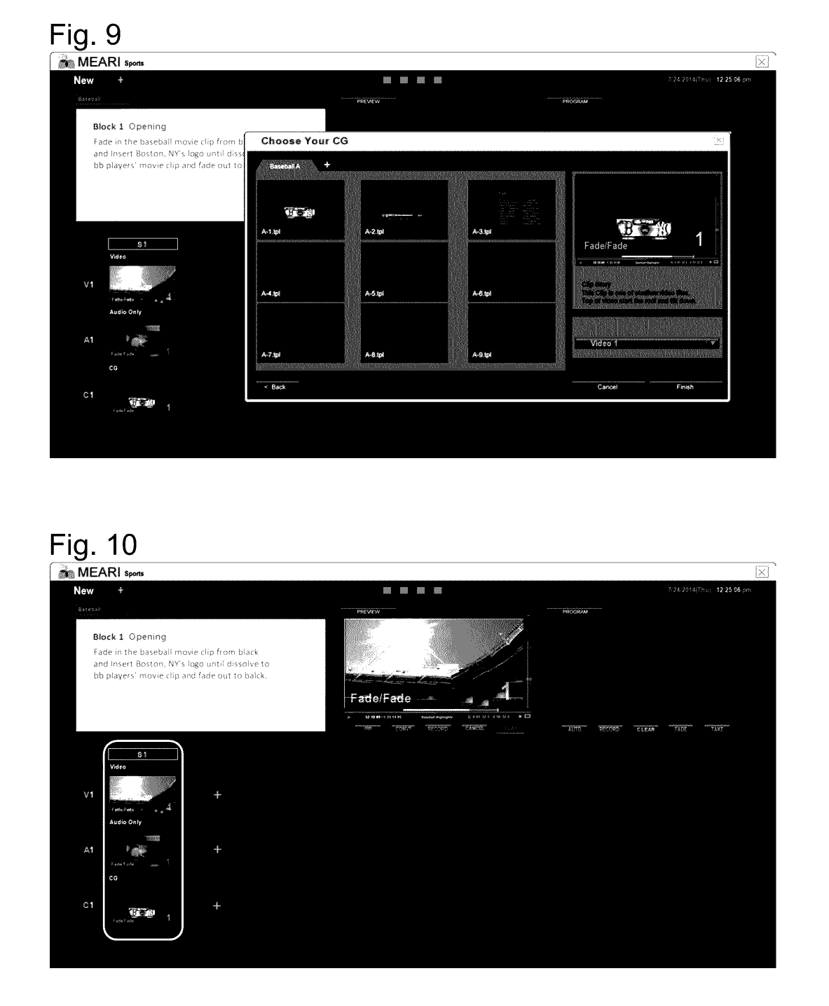

In FIG. 9, CG template is selected and used from the last Playlist. Using Clip Editor, Run Time and Audio can be controlled. By controlling Position of Timeline, a CG logo may be made to appear in 3 seconds and disappear in 2 seconds. If all is done, “Finish” is pressed, ending to select various Sources such as Video, Audio, CG, Source, etc.

In FIG. 10, since Video, Audio, and CG Title were selected for the Storyboard 1 (S1), there is one Clip in each of the Playlist 1, 2, 3. If clicking S1 after selecting Source for the first Storyboard, the first Clips of Playlist 1, 2, 3 are loaded in Preview, and starts to play (refer to the white rectangle). Check if the contents are same as what was recorded in Storyboard. If not good, it can be corrected by calling out the Clip in the Playlist to Source window with double clicks or correct the Clip directly in the Editor in Preview.

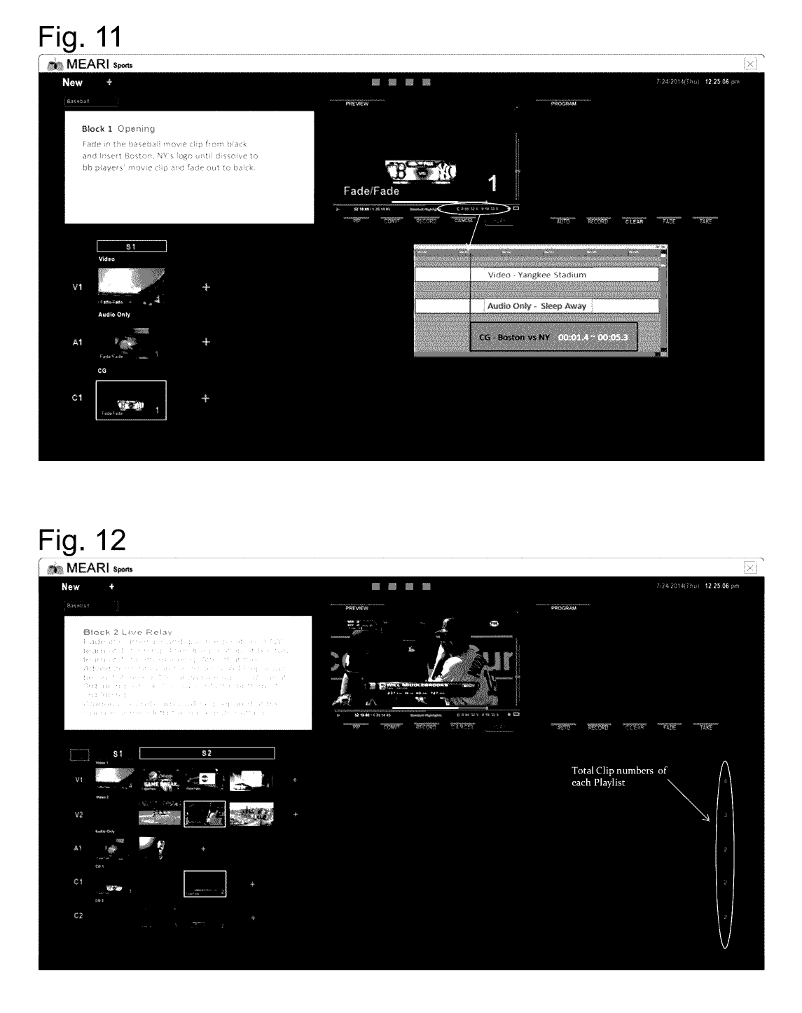

In FIG. 11, If the CG Title does not start on time and needs to be corrected, after loading the first CG in Playlist 3 in Preview, click Position of Timeline (yellow time display) on Clip Editor. If clicking the yellow time, Framed Timeline similar to the old Timeline is displayed, and the position of CG 1 to be adjusted appears with the time display. Since Video 1 and Audio Only 1 also appear, by moving right or left the position of CG 1, adjust so as to be in the desired time (refer to Framed Timeline).

In FIG. 12, since the contents of Story gets complicated, make all 5 Playlist by adding one more Video channel making two (Video 1, Video 2), and one more CG channel making two (CG1, CG2). Since the Sports contents will be used for Live, if there is a Live camera in the Source, the Camera number will be in instead of Clip. Such Live Source may be determined with a time for broadcasting using Clip Editor. At the end of Playlist is displayed the number of all Clips made in the Playlist, and if the Clips are too many to be displayed, it helps to know the total number of Clips. Since the disposing of Storyboard 2 (S2) is done, by pressing Play button while S1 is selected, check the result. If Play, the Clips are highlighted one by one in the order of appearing in the present Preview, it is possible to know which Clip is included in S2. If a correction is needed for Timing and the like, use functions of Clip Editor.

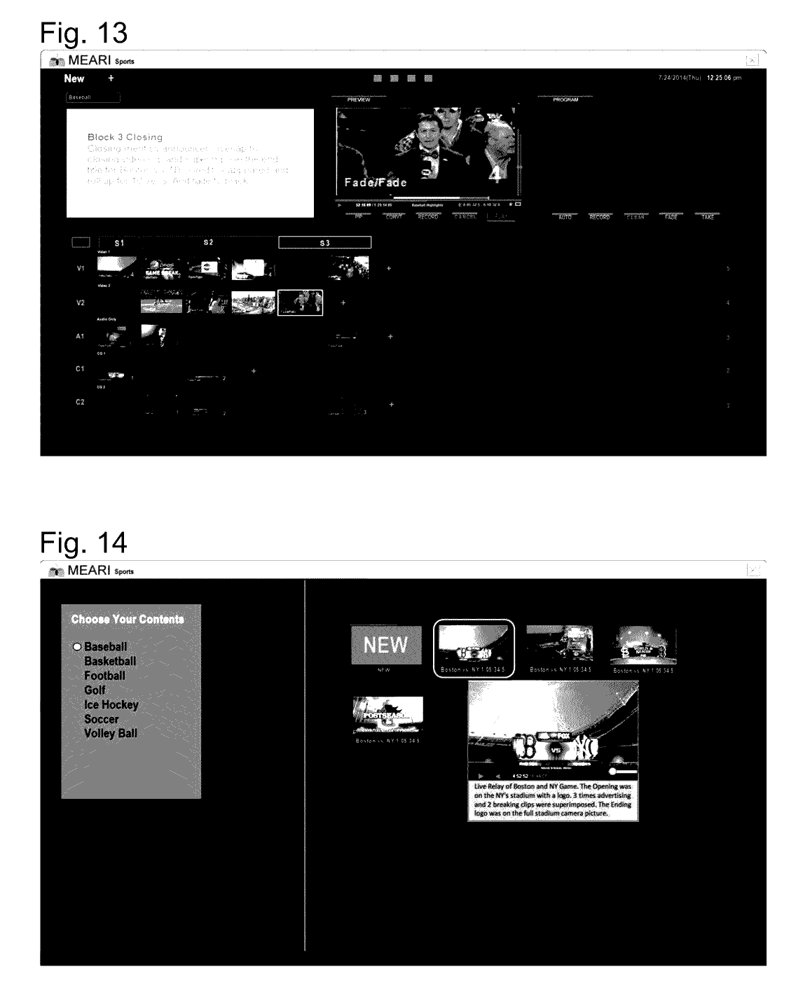

In FIG. 13, in Storyboard 2, the last part of the Live Contents is processed. In the last part, the Credit Roll is out with the last Clip of Video 1, and Audio Only is processed with a CD music. Once S2 is done, in a state of S3 selected, press Play button in Preview and check the contents. If there is no problem, press “All” (rectangle) on the top left of Playlist window, and play the entire Storyboard (S1, S2, S3). Since Storyboard 1, 2, 3 show in the order on the top left window in playing the entirety, it is possible to compare Story and check the contents. End writing of Contents for Live broadcasting for Boston vs NY.

In FIG. 14, a new contents can be made more quickly by selecting and correcting to use some similar old contents. Not choose New in the Contents window, but if bringing a cursor on a thumbnail of contents that was made already, Play starts with a big screen and sound. Since a game between St Louis and Boston is to be made and broadcast, look for similar contents to this baseball game. We can use the previously-made contents for Boston vs NY. Click the thumbnail containing Boston vs NY game.

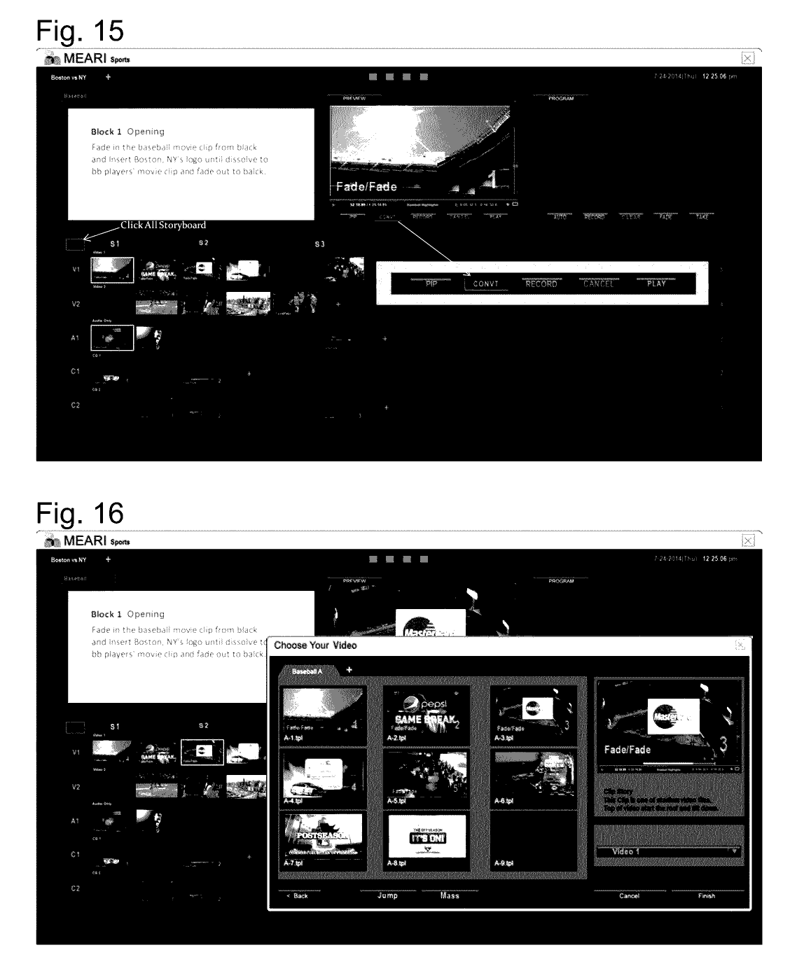

FIG. 15, if clicking the thumbnail of Boston vs NY, all the clips in the contents show up in the Main UI. It is possible to select Clips to load in Preview. To load all the Clips of the contents, click All button on the top left corner in Playlist. If wants to load according to Storyboard, choose number of Storyboard (S1, S2, Also, if wants to load a Clip on the Playlist, click the corresponding Playlist number. Then press Convert button in Preview window. This button makes the old contents templates and open Choose Your Video window for correcting one by one from the first Playlist (Video 1). That is, it removes Lock states of the contents and converts them to Templates, to be corrected easily.

In FIG. 16, if the Choose Your Video window appears, correct the records of Storyboard with Boston vs NY to be accustomed to St Louis vs Boston. Then a new Video Clip to be used according to the new Storyboard is looked for and replacet with. If double click Clip 6 in Choose Your Video window, for example, then Play begins and the user can check if the ad is a right one.

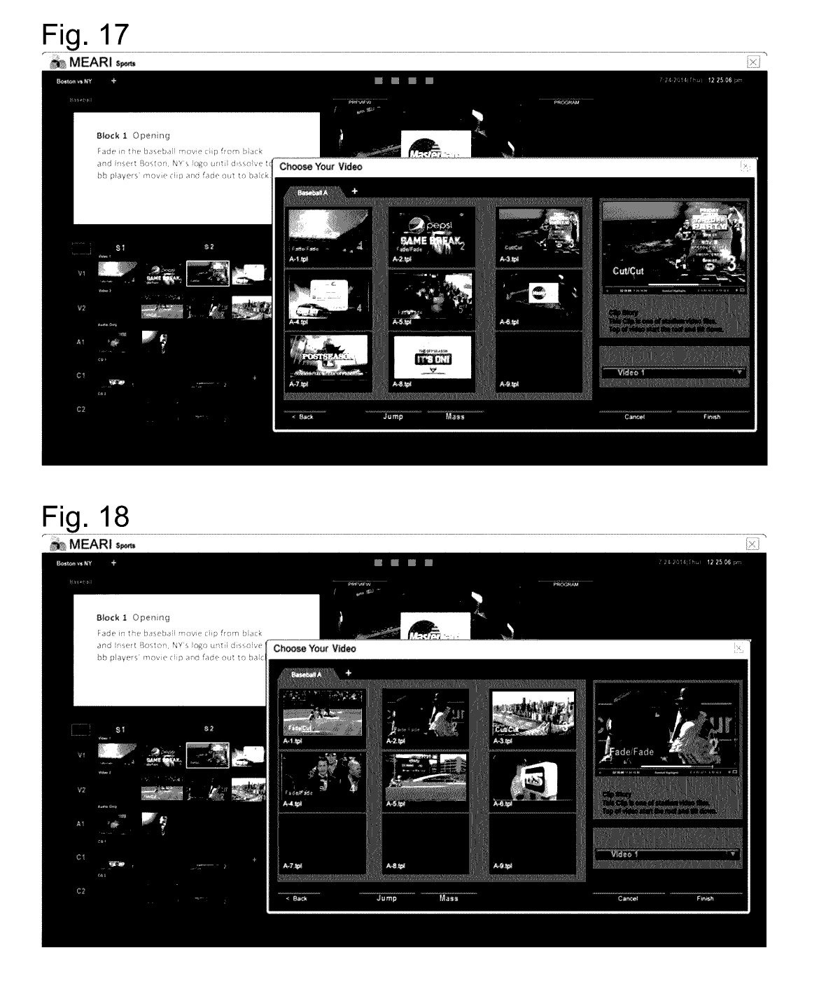

In FIG. 17, the newly chosen 6′ ad Video (no Playlist number) Clip is displayed as number 3 in Preview window. Clip's originally-assigned effect was Cut/Cut, but it can be changed using Clip Editor functions (refer to Clip Editor in the above). The old ad Video in number 3 was exchanged with the 6′ position, and the Playlist number disappears. This way old Clips in the current Playlist can be changed with new ones or corrected. If want to change Clips in order in the Storyboard, use Jump Button in the lower side of the Choose Video window. If want to go to the next Clip in the Storyboard from the number 3 that just has been done, press Jump Button.

In FIG. 18, it is shown to jump to Clip 2 of Video 2. Select the necessary Clip according to Storyboard of the new contents to make, and adjust Start/End time, Position of Template, Audio Volume, etc. If done with correcting all the Video Clips, select Finish and close Choose Video window.

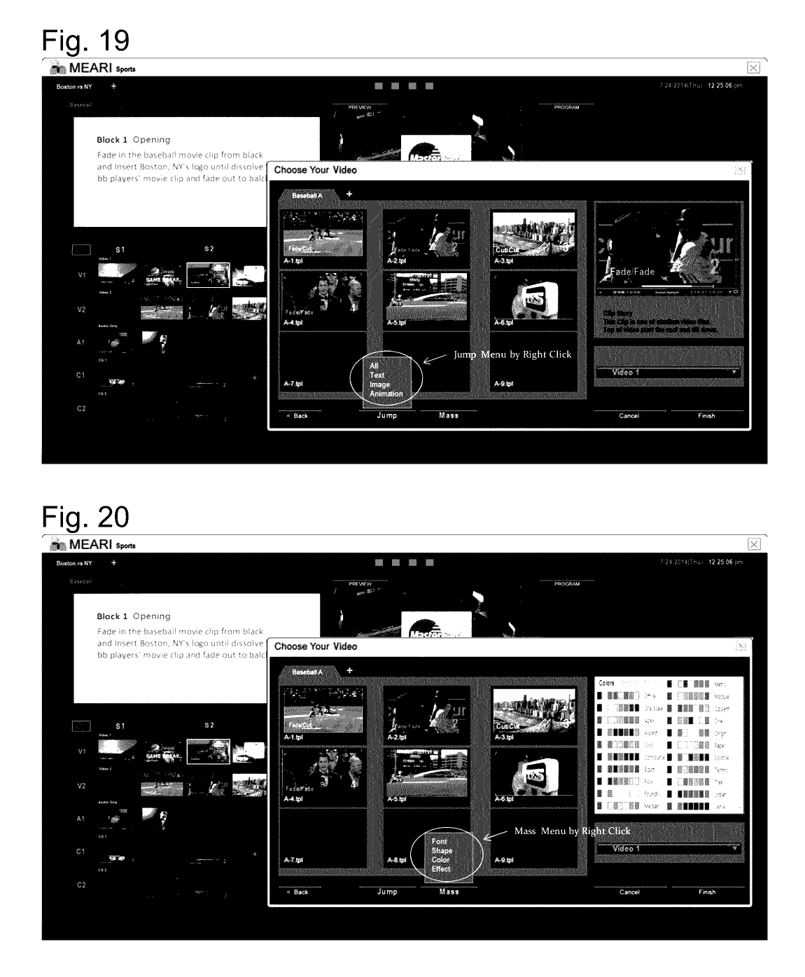

In FIG. 19, it shows how to jump in the CG Template according to the kinds of Object and how to change Color, Shape, or Font in batch. If right click in Jump button, Pull down Menu pops up and it is possible to select the kinds (All, Text, Image, Animation) of Object to change. If select one out of Text, Image, Animation, it jump to the corresponding Object and if press All, it jumps all the Object one by one.

In FIG. 20, right click at Mass button. If select one out of Font, Shape, Color, Effect, the screen is replaced with the Clips to change (Clips to change were determined before pressing Convert button.) To select a color, If Preview in the right is changed to Color Pattern, select one out of the Pattern, and select Mass button, it is converted to a color corresponding to Storyboard order (or Playlist order). (This is similar to PPT(R)). Font or Shape can be changed similarly.

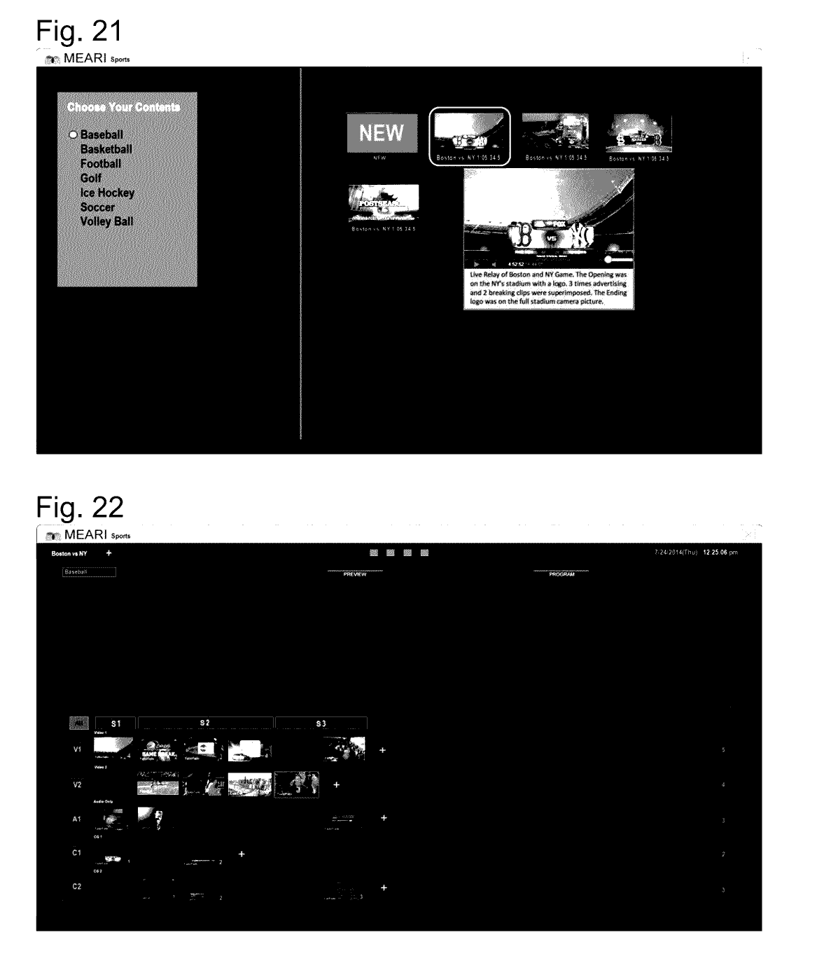

In FIG. 21, in order to Live broadcasting or recording, the contents must be called in from the starting portion of the PVP system. If related contents are displayed on selecting Sports item, put the cursor on them, check the enlarged screen and Audio, and then select the contents. For example, click the contents thumbnail containing the Boston vs NY game.

In FIG. 22, the initial screen shows after clicking the prepared Boston vs NY game. The top left portion of the screen is empty, and will display related content of Clip according to selection with cursor. Preview window and Program window on the right top will display ones selected by the cursor after loading. In the Playlist in the bottom portion, Clips to proceed manually or automatically are disposed, and in the Column the Blocks of Storyboard are laid in the order of S1, S2, S3, and in the Line the corresponding Clips will be disposed in order of kinds such as V1, V2, V3 (Video), A1, A2 (Audio only), C1, C2, C3 (CG). If want to add a Clip, press the green+ to open Choose window any time. Press All button on the top left of Playlist window to choose the entire Contents.

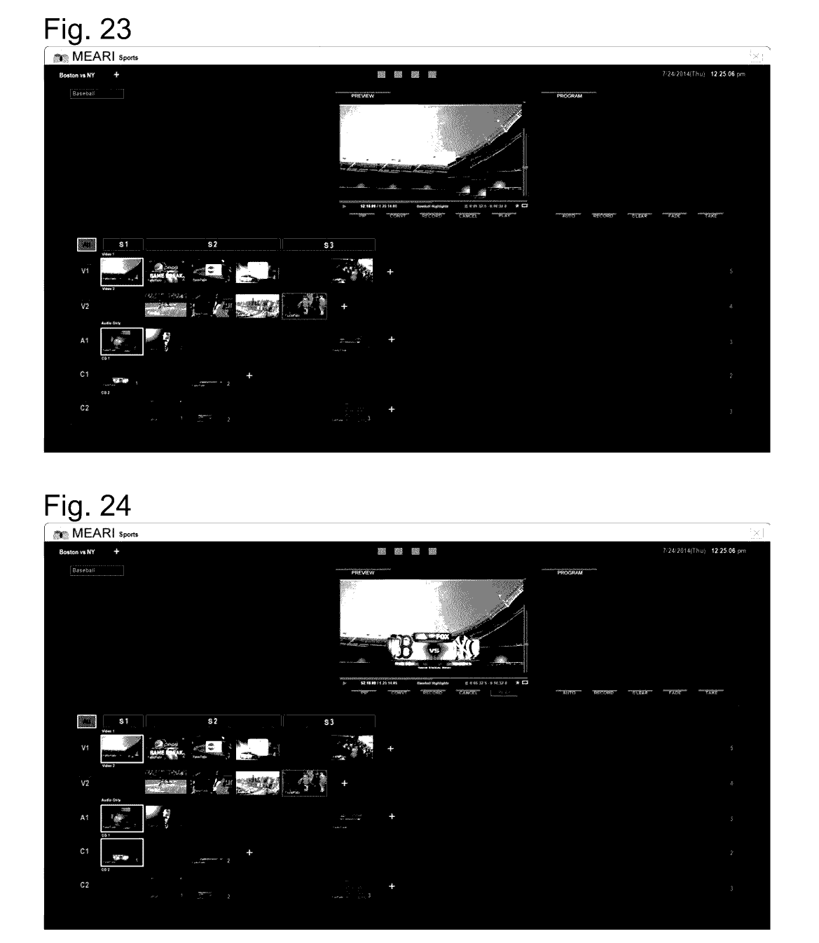

In FIG. 23, if click All button, it's highlighted and the first Clips in V1 and A1 in the Playlist window are highlighted, all contents in the Preview screen are loaded. The reason that the first Clips in V1 and A1 are highlighted is that the Video Clip stored as a File as the first Opening Video screen and the Audio File to be used as the Opening Music are loaded first in Preview. That is, in the order of appearing in Preview screen the white highlight appears on Clips, informing the situation being processed currently.

In FIG. 24, press Play button in Preview and start Preview Play. Since All was pressed, the user can check all the contents. If Play starts, as the contents recorded in the Storyboard, the prepared V1 and A1 go out as screen and sound, and after that the first caption C1 is processed.

This way, the entire contents can be checked. If it is impossible to check the entirety due to time problem, necessary sections such as S1, S2, V1, A1, etc. can be selected and checked.

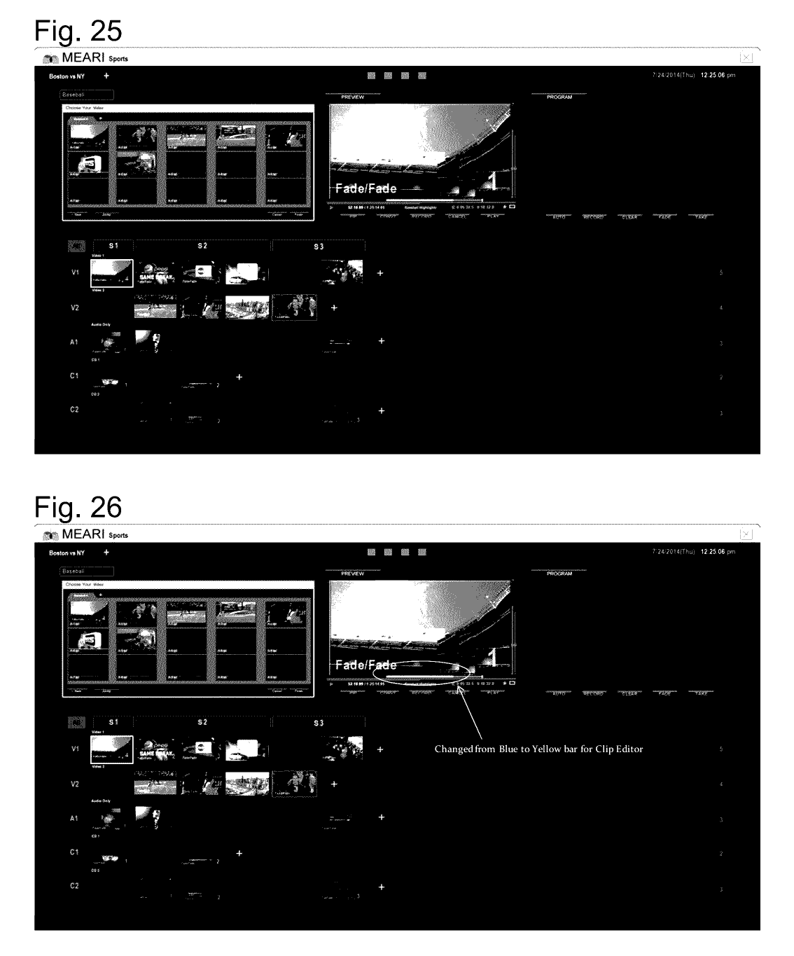

In FIG. 25, if there is anything that is not good or wrong, select the corresponding Clip with mouse or number in keyboard. For example, if the first Clip of V1 used for Opening is not good and the user wants to change it with other Video Clip, click the Clip. Then, the Preview window is converted to Clip Editor Mode, and other similar Video Clips in the same Folder (of the computer on which the PVP system is executing) as the corresponding Video Clip appear in the left Source window. That is, ‘Choose Your Video’ window, which was in the Planning, appears in a small size. If select a desired Video Clip, the first Clip in V1 is replaced with the new one. If there is a sufficient space on the Monitor screen or a second Monitor, the ‘Choose Your Video’ window may be taken out of the Source window. Here, the Clip Editor in Preview is introduced into ‘Choose Your Video’ window.

In FIG. 26, if select one Clip individually, not as a group such as S1, S2, . . . , V1, V2, the system loads it to Preview window considering to edit. Therefore, in a case of selecting the first Clip of V1, the Preview window changes to a Clip Editor (Yellow Runtime bar) instead of Preview window (Blue Runtime bar) shown previously. If want to adjust Run Time or Starting and Ending point, not changing the Video Clip itself, it can be done in the Clip Editor as described in the above. This helps a lot to correct a defective Clip in Live broadcasting.

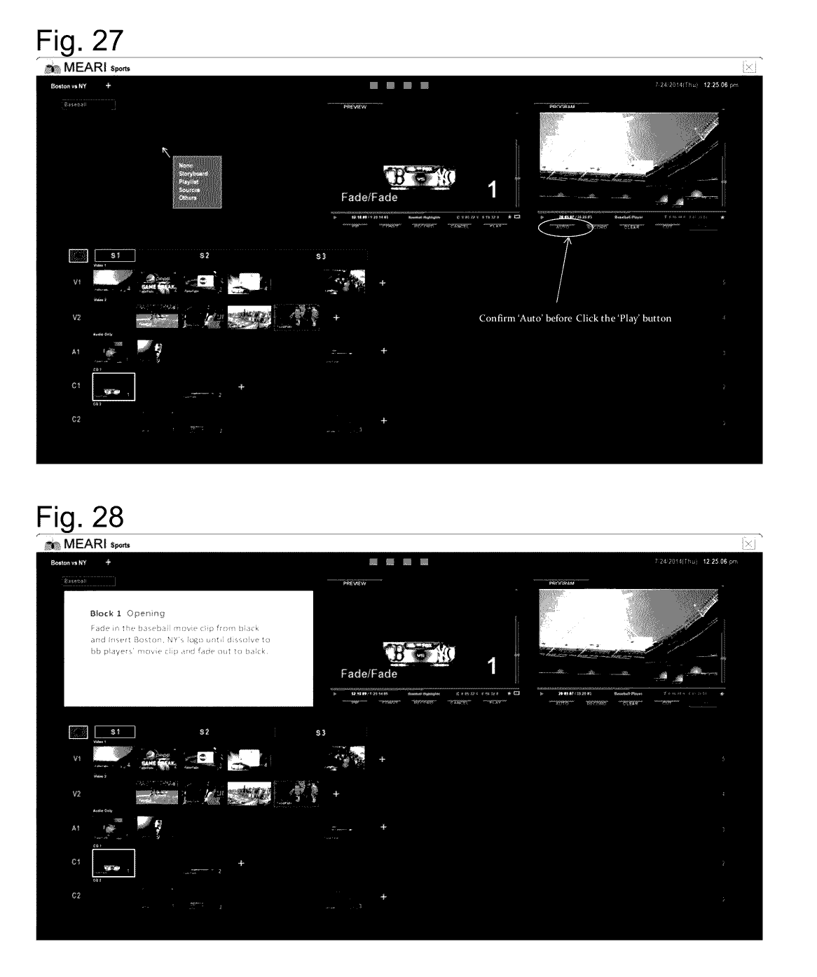

In FIG. 27, it is ready to make a Live or broadcast. The feature of Live is that since it cannot be stopped in the middle the user must be very careful to control. In order to minimize such human errors, the PVP system provides a function of Auto or Automatic Play. Prepare to load the entire contents in order to the PVP system by selecting All again. If Check whether the first button among five buttons below the Program window is set Auto, and click (one moment click, not holding) Take, the Clips of the first Storyboard (S1) loaded in Preview are loaded and start to play. All and S1 are highlighted in Playlist, and the first Clips of V1 and A1 are highlighted in red, and the first Clip of C1 is highlighted in white. Red highlight means that it is being broadcast. White highlight means that it is the next to be on the screen and selected in Preview. If right click in the Source window, a small menu appears with options including None, Storyboard, Playlist, Source, Other, and this is to select the kind to show on the window.

In FIG. 28, if select Storyboard in Menu, Storyboard appears one by one in the Source window. If select Playlist, Playlist Clips about Video, Audio, CG being processed currently appear. If select Source, the Sources appear according to the kind of Clip appearing in the Preview. None shows a state of selecting none, there is nothing in the Source window.

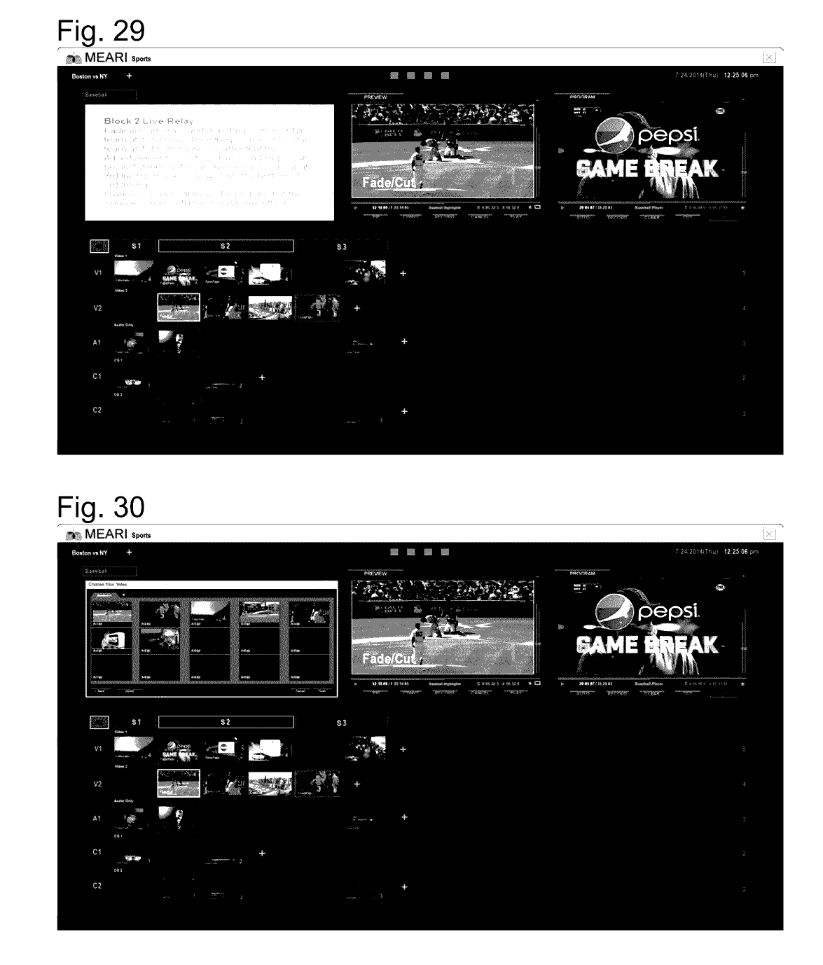

In FIG. 29, Clips of S1 are broadcast and now S2 is being played. Game Break Clip of V1 is being broadcast and for Audio the Microphone in Stadium is on-aired and the announcer is giving a mention. For CG, the first Clip of C2 connected to Team Score Data is being on-aired along. If the Game Break ends, it goes over to Stadium Camera. Since the Stadium Camera is operated separately by a broadcasting crew, the PVP system just receives the output to process.

In FIG. 30, if want to find out other Source screen in the Stadium appeared in Preview, right click the Source window and select Source in Menu. Then similar Video Sources in the same Folder in which the Clip on the Preview is or similar Video Sources appear in the Source window. (This can be determined arbitrarily by the user.) If a desired Clip appears, click it, play through Preview screen, and check. At that time, the previous Preview screen cannot be seen momentarily. This is not lost in Preview, but just viewing for a while using the Preview function to be on Source screen through Preview window.

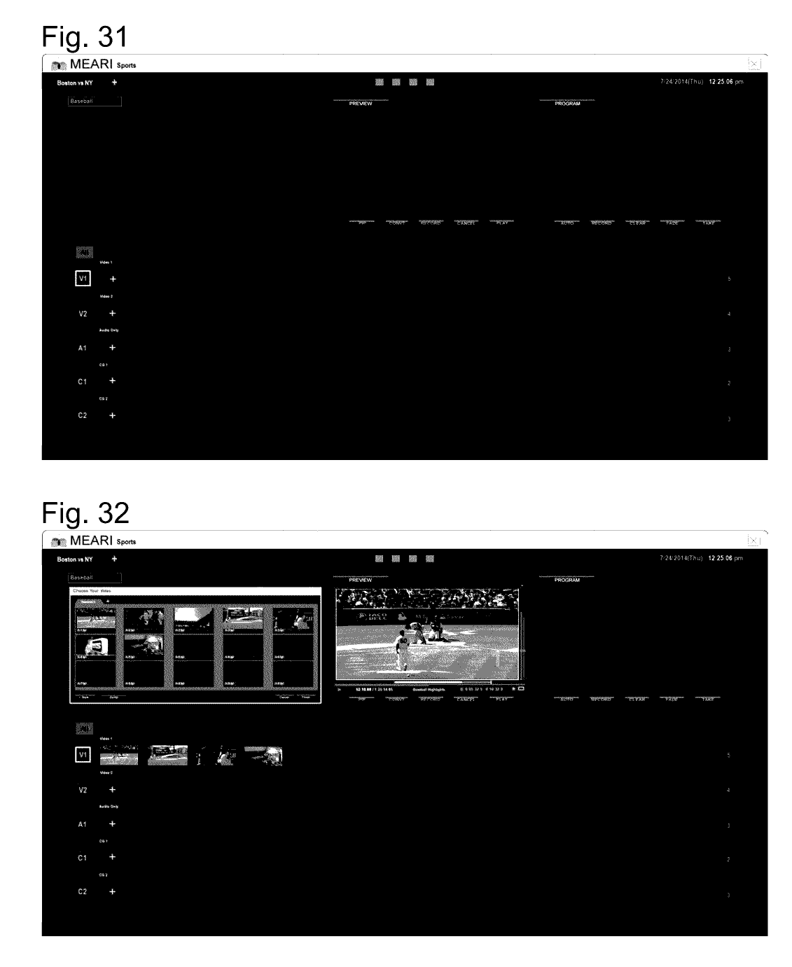

In FIG. 31, the reason of dealing with Live Producing manually is that a scenario is not ready or the present state must go on as Live. Since it needs to call in necessary data for Video, Audio, CG columns, click V1 number of the Playlist first. Then Clips related to Video appear in the top left Source window. (It is OK to press the green “+”, but in such a case, Choose your source window appears. It was described in the above).

In FIG. 32, find a desired Video Clip in the Source window and click. Then it changes to a Clip Editor Mode in the Preview window, in which the Start/End Time of the chosen Clips can be adjusted. On finishing to select, press Finish. Then, the selected Video Clips are shown in V1 Playlist. If the order was mixed in the Playlist, it can be changed by dragging the Clips.

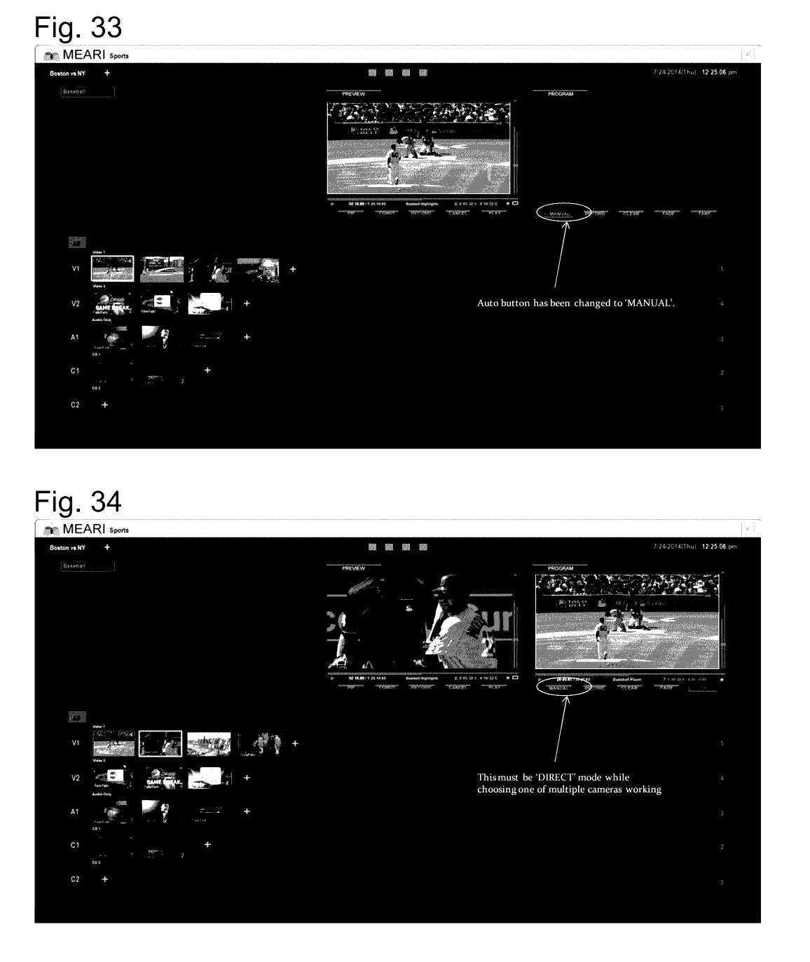

In FIG. 33, likewise, fill V2, A1, C1, C2, etc. If V1, A1, and C1 only are needed, right click the remaining V2 and C2 on Playlist region or names and delete. If click Auto button out of the five buttons in Program window in order to proceed the Live manually, then when selecting one out of ‘Auto’, ‘Manual’, and ‘Direct’, select Manual. The reason to change to Manual is because ‘Auto’ plays Clips automatically by the Storyboard but Manual proceeds manually. However, since when a Storyboard was not written the button is changed to ‘Manual’ automatically, there is no need to click any button. Since Manual selects Sources manually as in the conventional Switcher, select Video Clips in V1 and V2 and processes Audio in A1 as Live. CG is proceeded Live in similar way.

In FIG. 34, it shows a test of Preview of the first Clip (Camera streaming coming Live) of V1 as a first screen. In Playlist of V1 are disposed Live Streaming sources, and in V2 are collected Clips provided in Files. Since it is the time to begin broadcasting, if press Take button of Program in this state, the first screen of V1 in Preview is broadcast as Program (On-Air), and in Preview screen is loaded the second Clip of V1. If the next one is not the second of V1, and if select Source Clip to go out for the second time using mouse or keyboard, it is loaded to Preview right away, waiting Take button of Program to be pressed. If the user must select Camera 1, 2, 3 of the Stadium for him/herself or several Camera, for example, in a talk show programs, ‘Direct’ mode is used instead of ‘Manual’ mode. If set in Direct, the screen selected by mouse or keyboard is broadcast right away without via Preview.

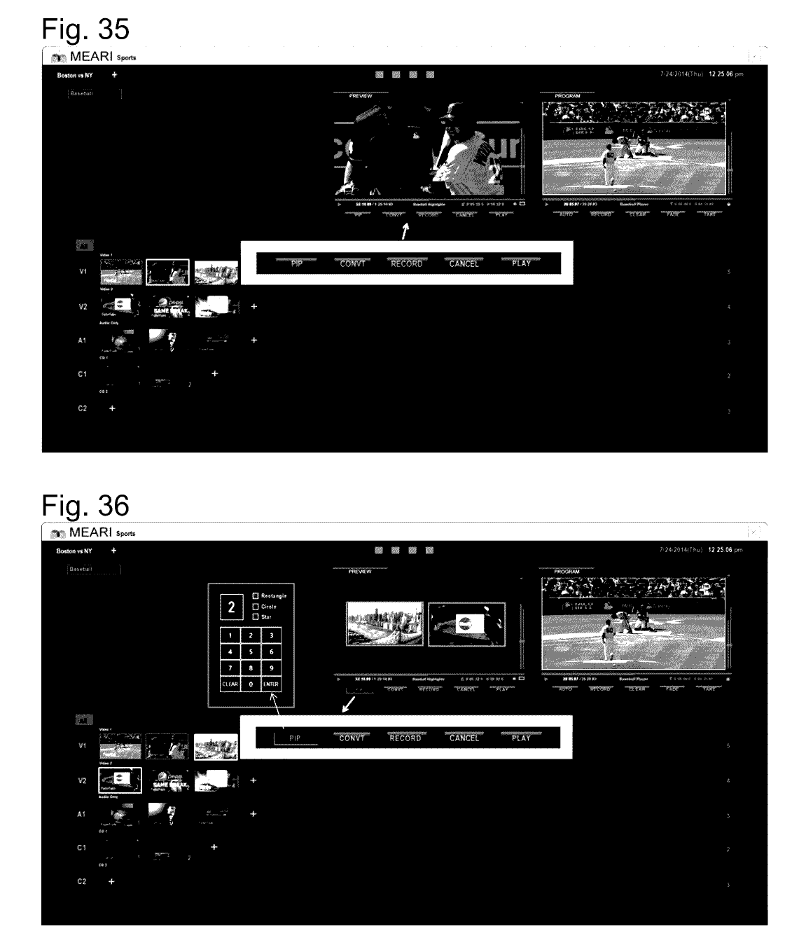

In FIG. 35, Preview window and buttons for Live broadcasting are described. Preview window has almost all displays that Clip Editor has basically (refer to the description of Clip Editor in the above). But there is no Start/End of Clip, for only the portion assigned already by Start/End of Clip is displayed in Preview. And Clip Editor is displayed as Yellow bar, but Preview as Blue bar. Preview has five buttons, and they are prepared all for Preview window.

In FIG. 36, it shows a picture in picture (PIP). Determine the number of Clips to be inserted to the screen and select Shape and adjust the Size. If press PIP button a separate Numeric Pad appears. If enter a number, then the number of PIP screens to show on the Preview is determined. Keyboard may be used instead of Numeric Pad. Adjusting of Size can be done by pulling lines of Shape with mouse. PIP Shape can be selected in Menu.

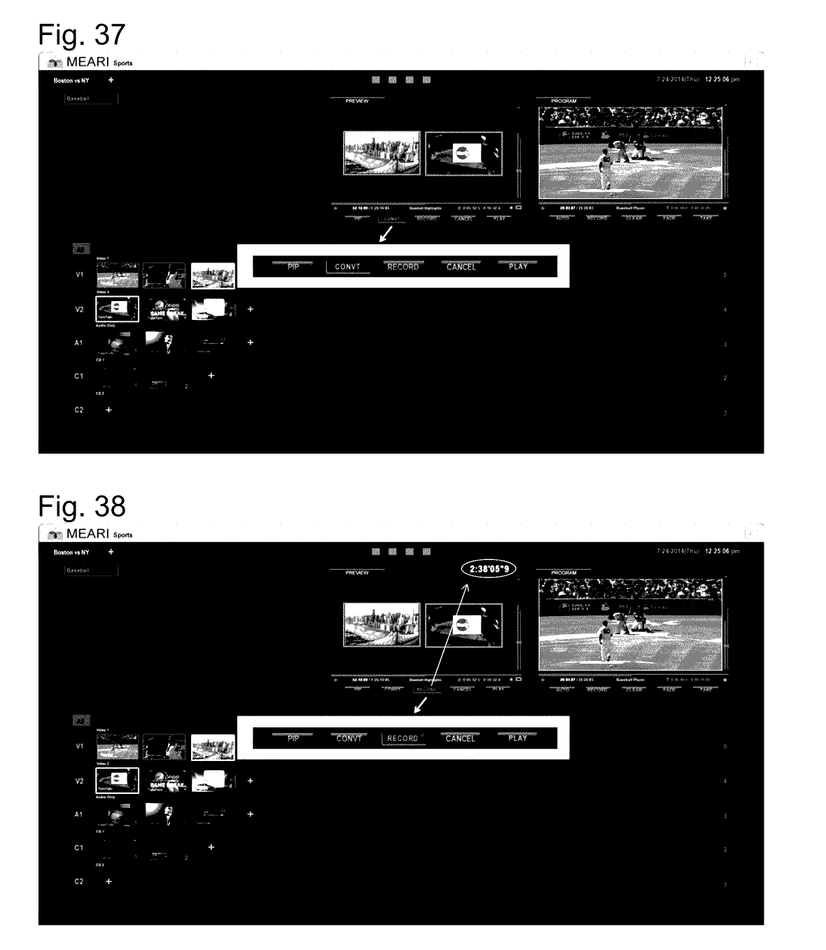

In FIG. 37, it shows Convert to Templates (CONVT). This is used for calling Contents that have been used and making CG Clips in it Templates. Jump Menu is used to jump to the next Video in order, and in CG it is used for selecting Text, Image, Animation and jump. Mass Menu is used for selecting Font, Shape, Color, Effect in CG and changing Clips in batch.

In FIG. 38, it shows Recording of Preview Play (RECORD). This enables to record what the Preview plays currently. Recording starts when Record button is pressed, and Run Time is displayed in the top portion of Preview screen as soon as the Recording starts. To stop Recording, press the Record button one more time.

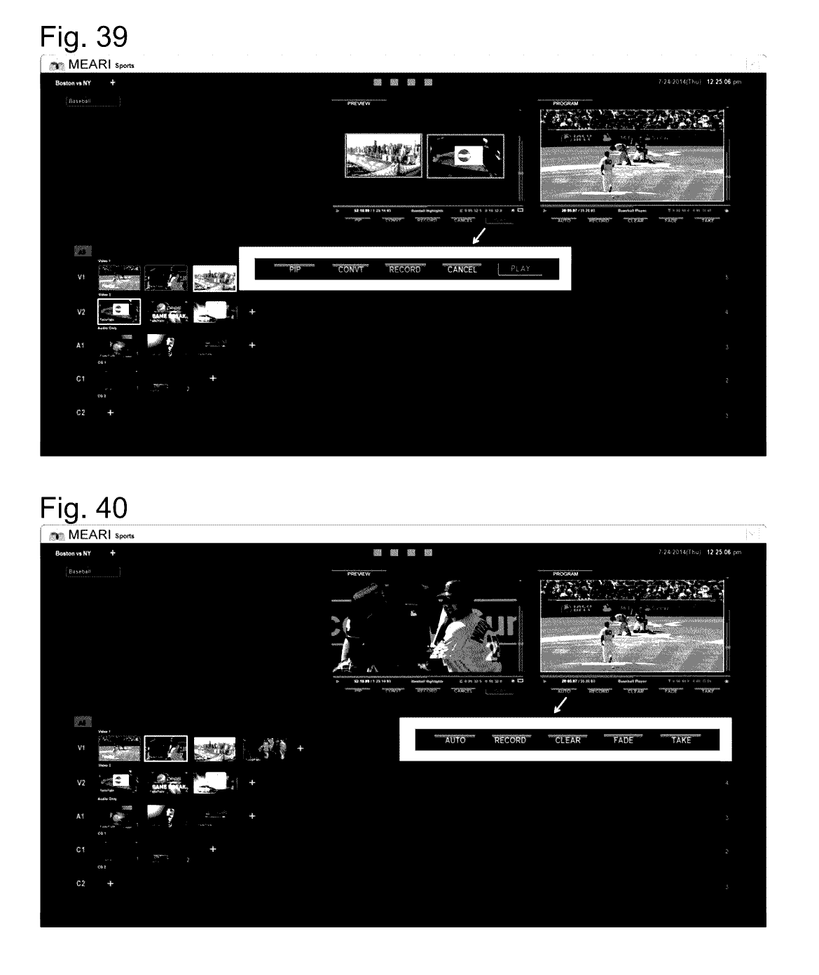

In FIG. 39, it shows CANCEL and PLAY (Preview Play, Pause, and Cancel). Cancel button cancels Clips being played in Preview and clears the loaded content. Play button is a toggle switch. One press for Play and another press for Pause. On the button, ‘Play’ is displayed in a state of Play, and ‘Pause’ in a state of Pause.

In FIG. 40, it shows Program Functions with Buttons. Program shows Play of Clip connected to On-Air. Program broadcast what was loaded in Preview directly without loading, saving the time for re-Loading. At that moment, a Clip next to the Clip being played in Program is shown in Preview. While it plays in Program, other Clips can be previewed in Preview. Still the state in Program is maintained.

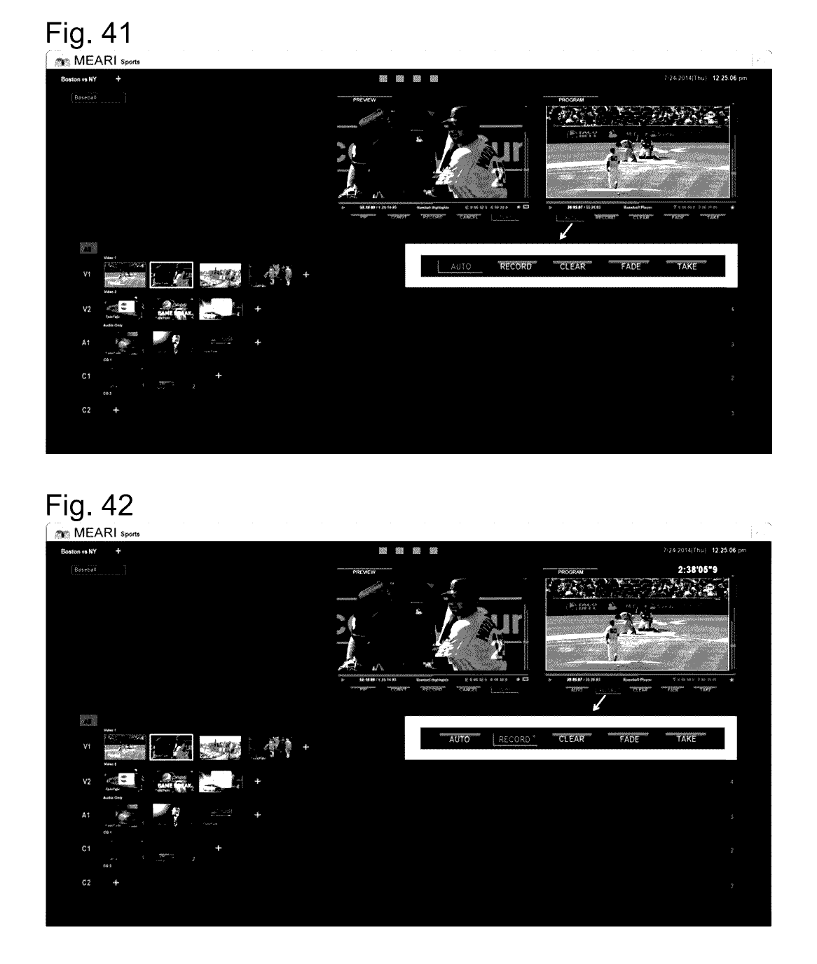

In FIG. 41, it shows AUTO (Automatic/Manual/Direct Play) Button. The user can make three choices by pressing Auto Button. Automatic: If press Take button in Auto, Clips in Storyboard are plays in order. Also in Live broadcasting, if set as Auto, switching is done automatically. In a case of Live Camera where the broadcasting time cannot be determined, while Auto Play, the Live screen can be switched manually. Manual: As discussed in the above, it is used when Storyboard is not ready and for instant broadcasting or recording. Even with a Storyboard, if set as Manual Mode, all must be operated manually. Direct: it broadcasts a selected Clip without going through Preview. Still, Automatic Play or Manual Play is maintained.

In FIG. 42, it shows RECORD, CLEAR buttons. Record button in Program records contents being broadcast in Program at the same time. Preview Record can record arbitrarily any time, but Program Record can record only when it is processed in Program. For showing the Recording time, the time is displayed in a top portion of the Program screen. Clear button in Program is used for stopping the Clip being played currently.

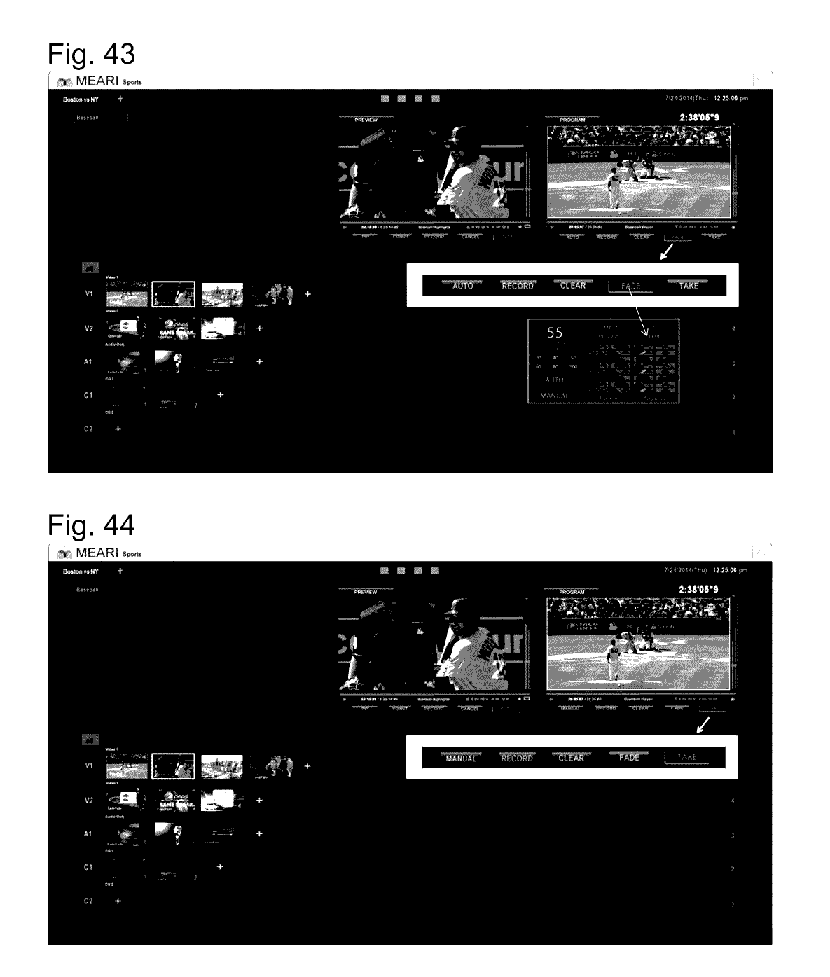

In FIG. 43, it shows FADE (Fade, Cut, Dissolve, Effect) button. FADE button is used for converting Video Clip from Program screen to Preview screen in Manual. If press FADE button, Effect Menu appears. From there, Transition kinds (Fade, Cut, Dissolve, Effect, etc.) and Transition speed (0˜100) can be selected. When FADE button is in Fade, if press Take button, the Program screen fades out, and Next Preview fades in. If FADE button is in Dissolve, the conversion between Program and Preview is dissolved. When FADE button is selected with one of Effect Pattern, the Transition effect appears between Program and Preview. But when it is set Auto, since Clip effect is set in Timeline in Storyboard, this FADE button does not operate but the name of effect is displayed.

In FIG. 44, it shows TAKE button. TAKE button has the same meaning as Take button in Switch. According to states of the other buttons, if press TAKE button, then it proceeds as the state is. So far the buttons are used for converting Video and Audio, but if CG is loaded to Next screen and prepared to broadcast to Program, then the buttons are converted to CG buttons.

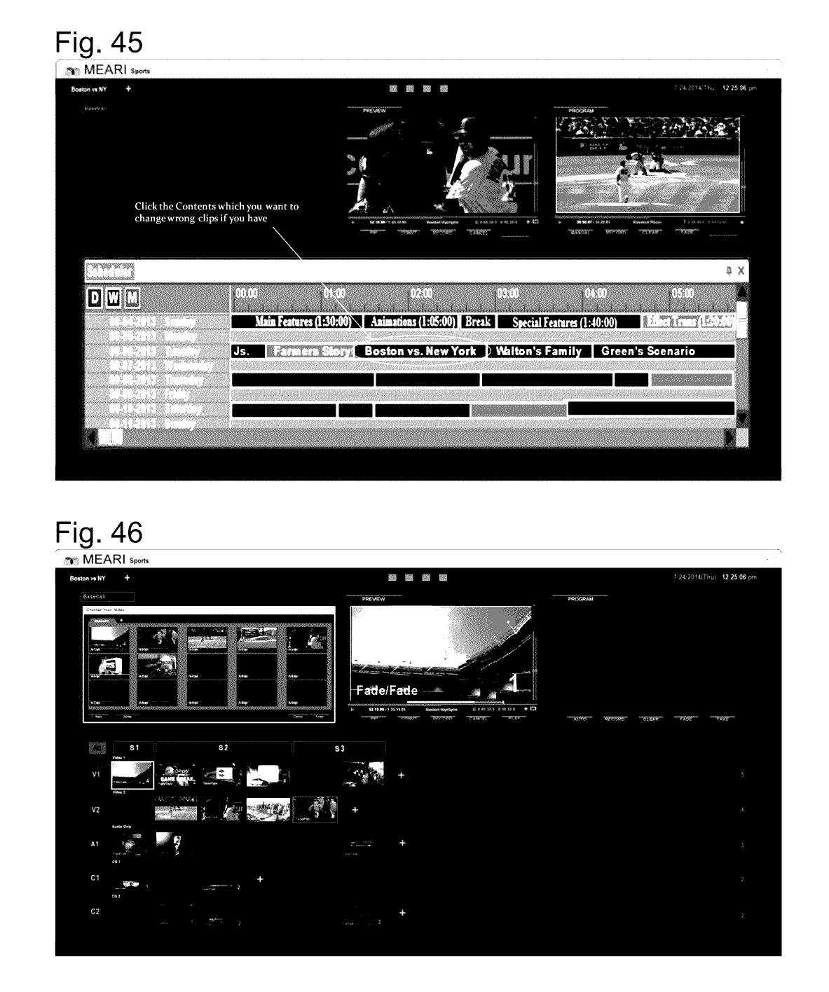

In FIG. 45, if a wrong Clip is found in Scheduler, that is, if a wrong Clip is in Boston vs NY contents to be broadcast on Tuesday as shown, click the Contents with mouse.

In FIG. 46, If select the contents, Clip change or correction can be done as discussed with respect to FIG. 25.

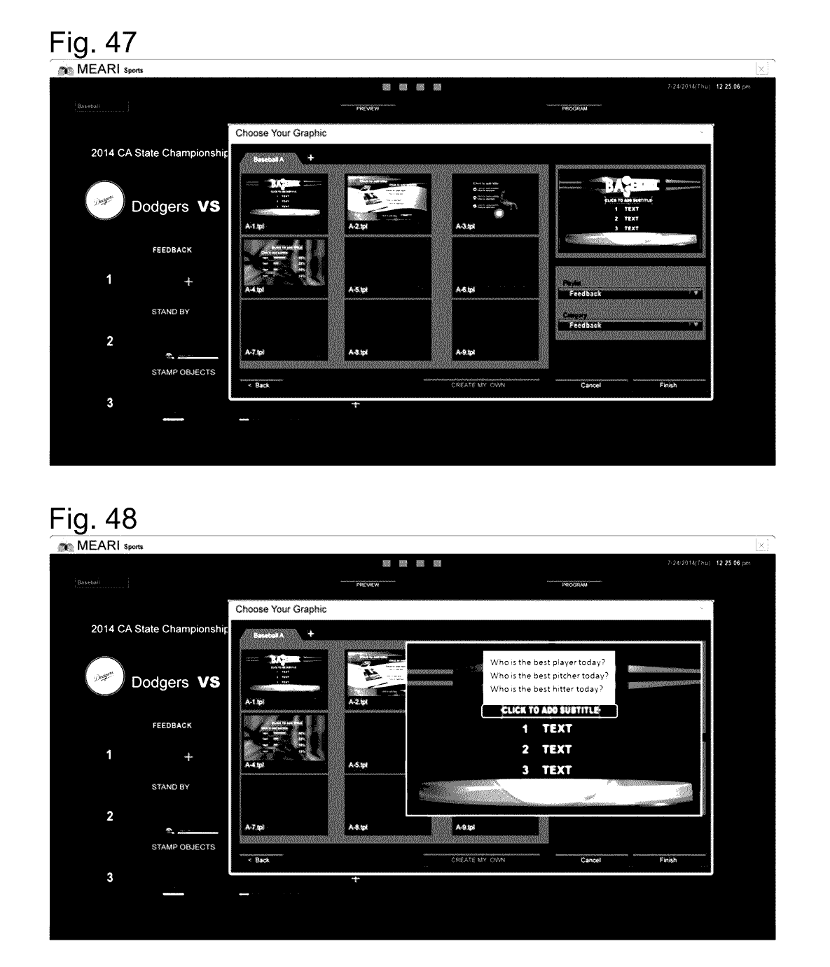

In FIG. 47, it shows how to make Questionnaire for Feedback from Audiance about the baseball game. If press “+Screen (Add New)” in Playlist, Choose Your Graphic window appears. In Pull down Menu in bottom right side, Playlist determines the name Feedback, and Category is set Feedback, so that Templates of Feedback can be shown. Move to Preview window by double click on the first Template. This Template is linked with Questionnaire Database, and Q and A can be fetched from the Database, or if not there, the user can type in directly.

In FIG. 48, if click Questionnaire items, question list regarding baseball is displayed. Select an appropriate one. If select a question, possible Answers stored in the Database are displayed as numbered choices. If there is no question in Database, the user can type in directly. But, in such a case, a right answer must be determined and it can be stored through Template Setting by clicking Right Mouse button.

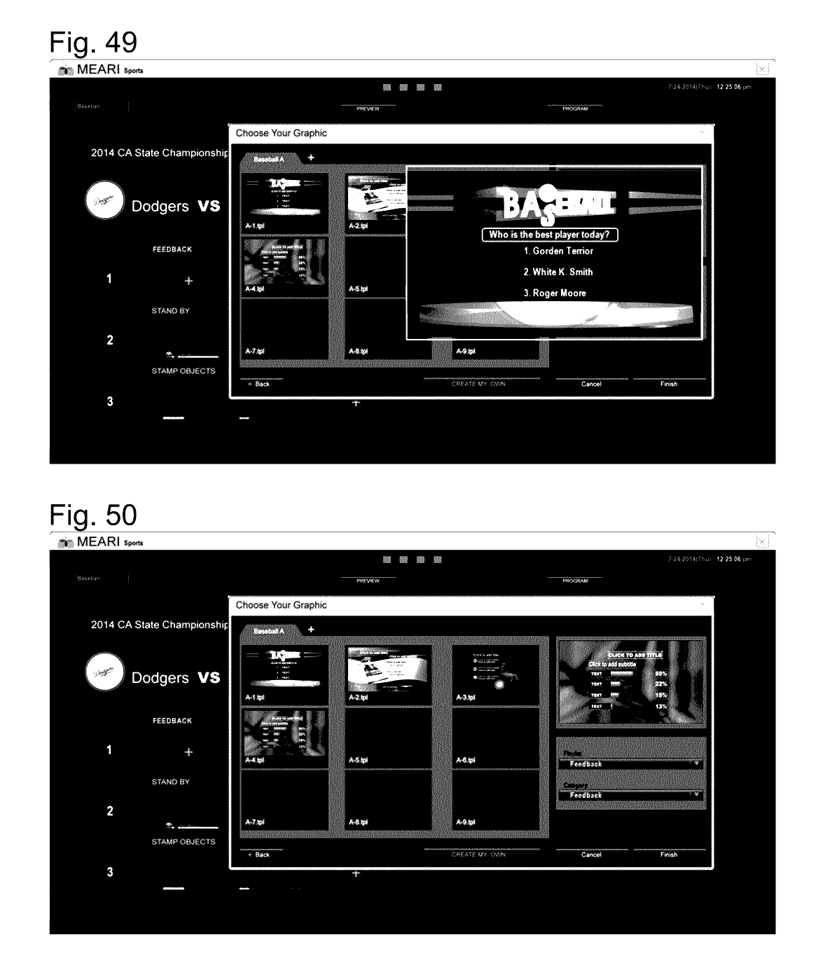

In FIG. 49, as soon as the question is selected, the answer is marked. The right answer is stored in Database, it can be known if Play in the process of Producing procedure. If this Questionnaire is broadcast, Audience selects number for answer through mouse, keypad, or mobile device, and the selection is stored in Audience Database through the Feedback function. After saving answers of Audience through this procedure, the system administrator analyzes them statistically, and broadcast the result to the screen.

In FIG. 50, the feedback result is made Template to show. There are two kinds, questionnaire and result, in Template for Feedback. The previous one is for questionnaire. Select Result Template and move it to Preview window.

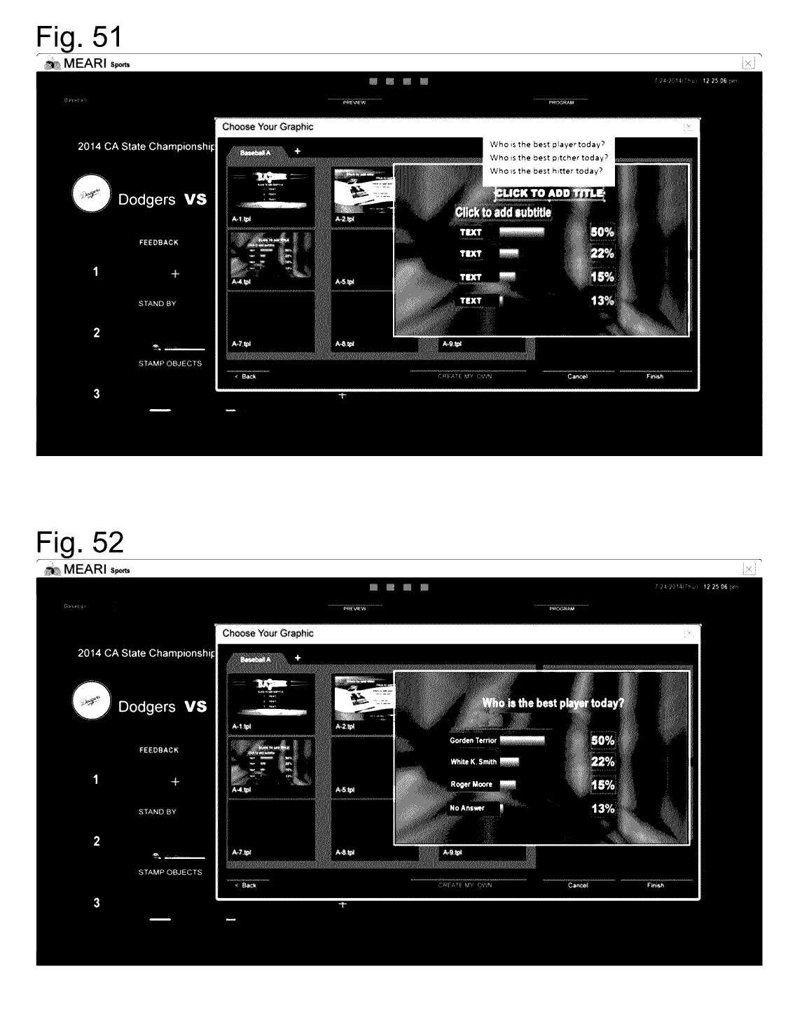

In FIG. 51, as before, if click Title, a list appears. If select the questions, three answers and No Answer are displayed with Audience percentage.

In FIG. 52, it shows the results. The survey on baseball is performed this way, and all the questions and Feedback results can be made in advance using Template. However, since numbers in the Results appear in real time during actual broadcasting, the illustrated numbers are just for showing, and the numbers will be updated with the results of Q and A in Live.

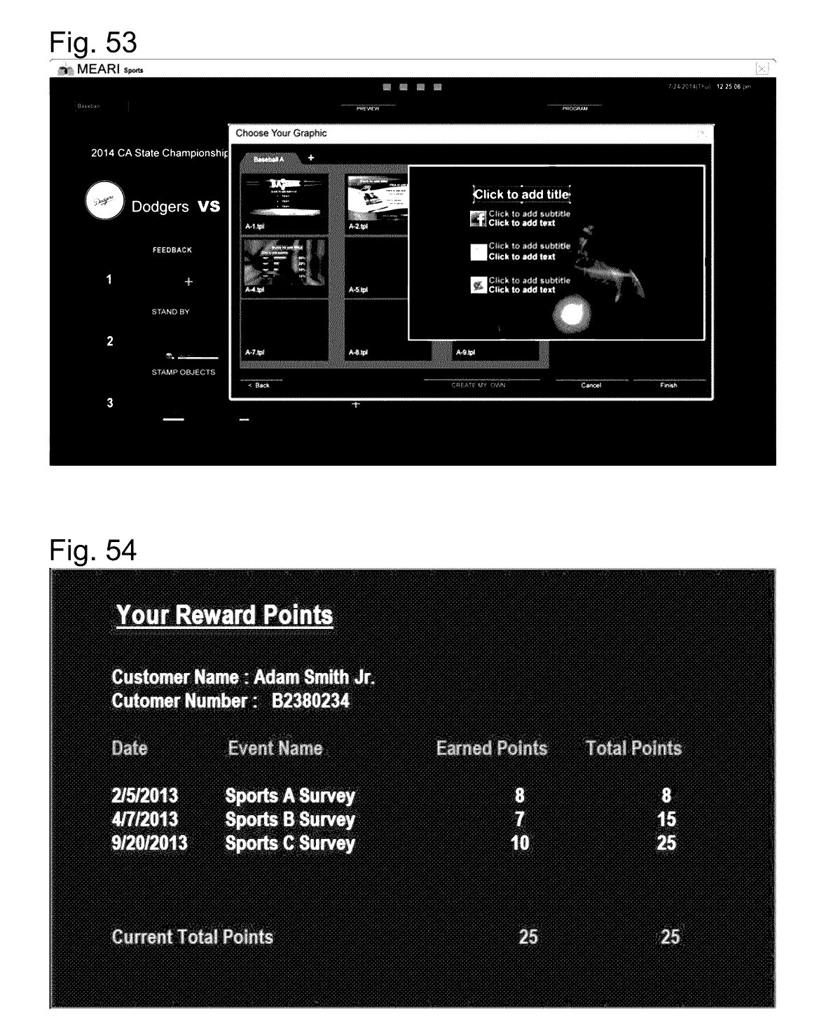

In FIG. 53, it shows how to connect to SNS. The Template can be connected to SNS for Data.

In FIG. 54, the Feedback can be used for Reward system based on Data provided by Audience through giving points.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A planned video production system with feedback, the system comprising:
a first planner module comprising a playlist with storyboard configured for storing production idea, selecting production data comprising live source, movie clip, audio clip, image, text, and graphics for the production idea directly on the playlist, and completing a functional storyboard;
a second planner module configured for selecting and making templates in ready-made contents, which is similar to contents-to-make, replacing or correcting a portion of the production data comprising video clip, audio clip, text clip, graphics clip, or event on the playlist while following or jumping over the production data in a predetermined order on the storyboard, and making the contents-to-make;
a producer module configured for playing information of all the clips and events stored with a storyboard on the playlist in the first and second planning modules, and recording or transmitting procedure of playing of storyboard in real-time and online or offline using manual or automatic switcher functions, each of which being customized for each type of clips;
a player module configured so that, while playing contents made in the producer module to an audience through a video on demand (VOD) or at a predetermined time using a time scheduler, when it is necessary to change a portion of the contents, if selecting the portion of the contents to change, the player module displays a corresponding playlist and finds a point to correct on the playlist;
a feedback module configured for making a plurality of questionnaires of 2-dimensional, 3-dimensional, text, and graphics including image and animation into questionnaire-templates, storing the questionnaire-templates in a database, analyzing feedback data from the audience according to the user's necessity, and displaying an analyzed results in 2-dimensional, 3-dimensional, text, and graphics image, or animation; and
a reward module configured for summarizing the feedback data of each audience, presenting an individual score reflecting the summarized feedback data, providing a reward to the audience according to a policy of a system user.

2. The planned video production system with feedback of claim 1, wherein the first planner module is further configured for allowing the user to determine production data on the timeline at the same time while making the storyboard, so as to enable the player module to perform a file recording or a live broadcasting directly without additional works using a completed playlist.

3. The planned video production system with feedback of claim 2, wherein the first planner module is configured to deal with three types of clips of video, audio, and text and graphic (CG), and when it is needed to broadcast several events and clips simultaneously on a screen, a number of lines in the playlist is increased such as Video 1, Video 2, Video 3, . . . , Video n, Audio 1, Audio 2, Audio 3, . . . , Audio n, and CG1, CG2, CG3, . . . , Cgn.

4. The planned video production system with feedback of claim 3, wherein if a contents made by the second planner module is loaded so as to dispose events and clips on the playlist entire or partial portions of the contents is converted to templates and each of the events or clips is able to be replaced with another desired event or clip individually, such that empty or overlapped play time is rearranged automatically.

5. The planned video production system with feedback of claim 4, wherein when the producer module combines a plurality of live video and audio source from outside with video clip, audio clip, or CG clip that were made already and broadcasts in real-time through switching and mixing, broadcasting times for input source, video clip, audio clip, and CG clip are predetermined, such that the live broadcasting in real-time is performed by using an automatic button.

6. The planned video production system with feedback of claim 5, wherein a broadcasting order of the input source, the video clip, the audio clip, and the CG clip and broadcasting start point and end point for each of them are assigned and the assigned information is represented on corresponding event or clip and concurrently the event and clip including live source, video clip, and CG are disposed automatically on assigned positions of the playlist.

7. The planned video production system with feedback of claim 6, wherein when the video clip, the audio clip, and the CG clip provided by the producer module are broadcast, properties of control buttons of the producer module change according to the kind of the video, audio, and CG automatically so as to optimize the control buttons.

8. The planned video production system with feedback of claim 7, wherein the reward module is further configured for allowing each of the audiences to see score that the audience won by providing an individual database, reading out score data accumulated in the individual database, and sending a content of the score data that the audience wants to a mobile device or terminal of the audience, such that the audience gets interested in results of feedback and is encouraged for a further participation.
